(19) United States
(12) Patent Application Publication
(10) Pub. No.: US 2011/0120412 A1
(43) Pub. Date: May 26, 2011

(54) Valve

(75) Inventor: Thomas Hannewald, Griesheim (DE)

(73) Assignee: Continental Automotive GmbH, Hannover (DE)

(21) Appl. No.: 12/530,385

(22) PCT Filed: Feb. 8, 2008
(86) PCT No.: PCT/EP2008/051573

§ 371 Date: Sep. 8, 2009

(30) Foreign Application Priority Data
Mar. 5, 2007 (DE) 102007010536.5

(51) Int. Cl. F16K 7/18; F02D 9/18

(52) U.S. Cl. 123/337; 251/901; 251/331

(57) ABSTRACT

A valve having a housing with a flow opening with a flat boundary. The flow opening is connected on one side to an elastic film element, which seals the flow opening in the flat state of the element. The valve is used as a throttle element for motor vehicles with diesel engines.

### PRIORITY CLAIM

This is a U.S. national stage of application No. PCT/EP2008/051573, filed on Feb. 8, 2008, which claims Priority to the German Application No.: 10 2007 010 536.5, filed: Mar. 5, 2007, the contents of both being incorporated herein by reference.

### BACKGROUND OF THE INVENTION

1. Field of the Invention

The invention relates to a device for generating a negative pressure in an inlet manifold of a diesel engine with a valve and to the use of the valve.

2. Prior Art

Valves are known. DE 102 51 384 A1 describes a valve, which comprises a housing having a valve seat for a flap, which is rotatably supported on a drive shaft. A first piston sealing ring and a second piston sealing ring are arranged in a circumferential groove of the flap externally surrounding the flap. A disadvantage with this valve is that the flap has to be adjusted in order to achieve the desired sealing effect, and this is relatively intricate. The flap is furthermore relatively expensive to design and produce.

DE 37 33 441 C1 discloses a non-return valve for arrangement in an intake port of a quantity-controlled internal combustion engine having a flexible closing element intended to open the intake port during the aspiration of combustion air.

U.S. Pat. No. 4,962,783 shows a throttle valve having an additional opening in its face, which can be closed by means of a flexible closing element. DE 89 01 561 U1 discloses a rotary slide valve having an elastic sealing element arranged in a lateral port in parallel with a throttle valve.

Further valves are disclosed by U.S. Pat. No. 3,771,563 A, DE 25 22 084 A1, U.S. Pat. No. 6,173,640 B1, CH 258937, U.S. Pat. No. 3,773,077 and CH 374590 together with CH 298612.

### SUMMARY OF THE INVENTION

An object of the invention is to create a valve in which the disadvantageous adjustment of the flap and a costly valve design configuration are avoided. A further object of the invention is to create a special use for the valve.

The object of the invention is achieved by a valve which comprises a housing having a flow opening with a flat boundary connected on one side to an elastic film element, which closes the flow opening when said element is in the flat state. The term flat boundary is defined as a planar boundary, which allows a plane planar element to rest against it. However, it may also be of concave or convex design shape so that the elastic film element conforms to the locally flat boundary. The flat boundary is therefore configured such that the elastic film element can be continuously applied and permits closing of the flow opening. The elastic film element is preferably at least partially curved, which can be brought into a flat state by a force. The valve may be composed of plastic or metallic material. The valve allows a smooth inlet and outlet of flowing media. In one embodiment, where the flowing media are liquids, it is generally preferable to provide the flat boundary with corresponding sealing elements. The sealing effect is achieved by the flat boundary being a thin-walled design, so that the contact forces are thereby increased, which may possibly avoid the need for using additional sealing elements. The disadvantageous arrangement of a valve flap, which is generally associated with a disadvantageous adjustment, is dispensed with. The valve is advantageously of relatively simple design, since to open or close the valve only tensile or compressive forces need to be introduced into the elastic film element, in order to correspondingly open or close the flow opening.

In a particular embodiment of the invention, one side of the flat boundary is connected to one end of the elastic spring element. This makes it possible to optimally minimize the overall design space of the valve.

According to a further preferred embodiment of the invention, the elastic film element is connected to a transmission part for the tensile or compressive forces. The transmission part is fixed, for example, to that side of the elastic film element situated opposite that side of the elastic film element, which is connected to the flat boundary of the flow opening. For example. As the transmission part, may comprise an elastic part, or a corrugated element, which then acts in the form of a drawbar or pushrod. The embodiment of the transmission part here also depends on the design configuration of the actuator.

According to a further preferred embodiment of the invention, the elastic film element is guided in at least one guide. In this way, the elastic film element is laterally fixed in operation, which increases the stability of the valve. To ensure a compact valve construction, it is generally advantageous to arrange at least one guide on the housing. At the same time it is advantageous to arrange two guides on the housing, which are arranged opposite one another and which grip around the elastic film element.

According to a further preferred embodiment of the invention, a scroll spring element is provided as elastic film element. The scroll spring element is a coiled strip, which without the action of a force automatically returns from the flat state into the coiled state and is held in this position. It is advantageous if tensile forces only have to be introduced into the elastic film element in order to close the valve. If the valve is then to be opened, it is not necessary to introduce compressive forces into the elastic film element, since said element can be spontaneously brought into the coiled state under its inherent elastic tension. This allows an especially simple design construction of the actuator required for operation of the valve.

According to a further preferred embodiment of the invention, an elastic sheet-metal strip is provided as elastic film element. This makes the valve simple to manufacture.

According to a further preferred embodiment of the invention, the flow opening encloses a grille on its flat boundary. The grille may be a metal grille, which is arranged in the housing. It is also possible to produce the housing and the grille as one single part. This advantageously facilitates the contact of the elastic film element against the flat boundary of the flow opening. The valve is furthermore of relatively compact construction, which increases the overall stability of the valve, especially in the case of larger pressure differentials.

The invention further relates to the use of the valve as throttle element for motor vehicles fitted with diesel engines. Motor vehicles fitted with diesel engines have throttle elements that serve to generate a negative pressure in the inlet manifold. These throttle elements should be of the simplest possible design. The compact construction of the valve allows it to be used to particular advantage as a throttle element for motor vehicles fitted with diesel engines, it being relatively easy to ensure the generation of negative pressure.

### BRIEF DESCRIPTION OF THE DRAWINGS

The invention will be explained in more detail below and by way of example with reference to the drawings in which:

FIG. 1 is a perspective view of a valve in an opened state in;

FIG. 2a is a side view of the valve of FIG. 1 in the opened state;

FIG. 2b is a top view of the valve of FIG. 1 in the opened state;

FIG. 3a is a side view of the valve in the closed state;.

FIG. 3b is a top view of the valve of FIG. 1 in the closed state;

FIG. 4 is a perspective view of another embodiment of a valve in the closed state;

FIG. 5a is a side view of the valve of FIG. 4 in the closed state ;

FIG. 5b is a top view of the valve of FIG. 4 in the closed state;

FIG. 6a is a side view of the valve of FIG. 4 in the opened state ;

FIG. 6b is a top view of the valve of FIG. 4 in the opened state.

### DETAILED DESCRIPTION OF THE DRAWINGS

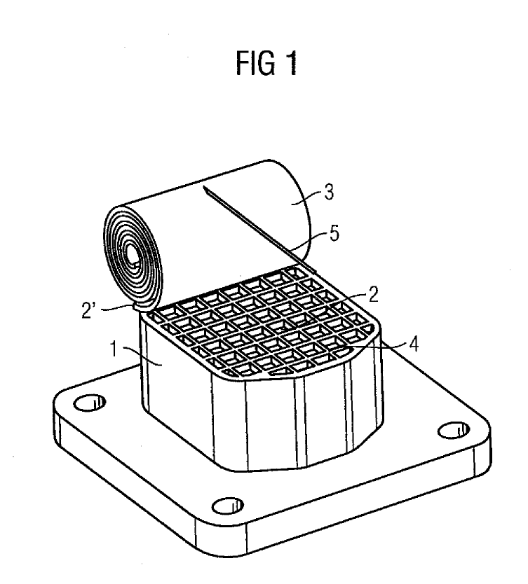

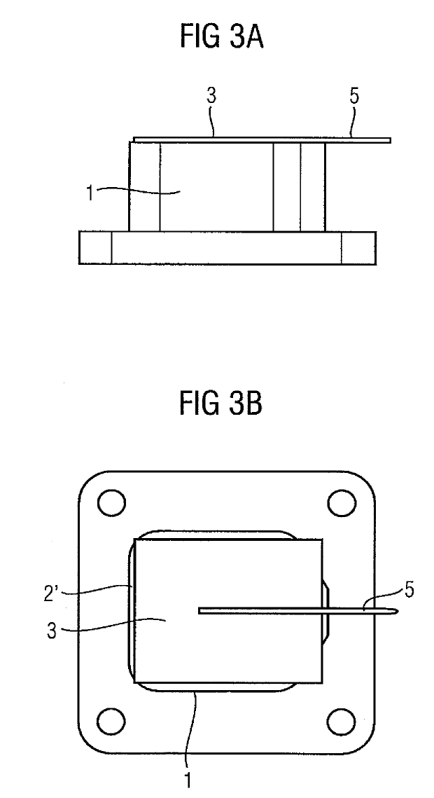

In FIG. 1 the valve is represented in the opened state in a perspective view. The valve comprises a housing 1 having a flow opening 2 with a flat boundary. The flow opening 2 is connected on one side 2′ to an elastic film element 3, which is capable of closing the flow opening 2 when said element is in the flat state i.e., FIG. 3a. The elastic film element 3 is arranged as a scroll spring element and is connected to a transmission part 5 for transmitting tensile or compressive forces. The transmission part 5 is preferably an elastic corrugated element, which is connected to an actuator (not shown) for the valve. For reasons of clarity the connection of the transmission part 5 to the elastic film element 3 is indicated only schematically. The elastic film element 3 is connected to one side 2′ of the flat boundary of the flow opening 2 at one end of the elastic film element 3. At its flat boundary the flow opening 2 encloses a grille 4. This grille 4 is preferably produced as a single part together with the housing 1.

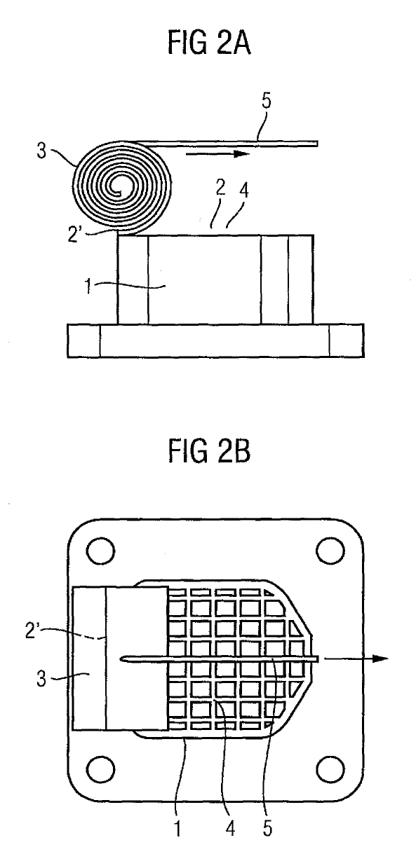

In FIG. 2a, the valve is depicted in the open state in side view according to FIG. 1. In FIG. 2b, the valve is represented in the open state in top view according to FIG. 1. If the valve is to be closed, it is necessary to transmit tensile forces into the elastic film element via the transmission part 5. This is done in the direction of the arrow.

In FIG. 3a, the valve is depicted in the closed state in side view. In FIG. 3b, the valve is depicted in the closed state in top view. Starting from the position represented in FIG. 2a, an introduction of tensile forces into the elastic film element 3 via the transmission part 5 causes the elastic film element 3 to uncoil until it is in the flat state closing the flow opening 2. In order to then open the valve, it is merely necessary to ensure that no forces of any kind are introduced into the elastic film element 3 via the transmission part 5, so that it is automatically returned to the coiled state i.e. FIG. 2a, and therefore again attains the opened state represented in FIG. 1 and FIG. 2a. This can be done without expending any compressive forces, since a scroll spring element is preferably provided as elastic film element 3.

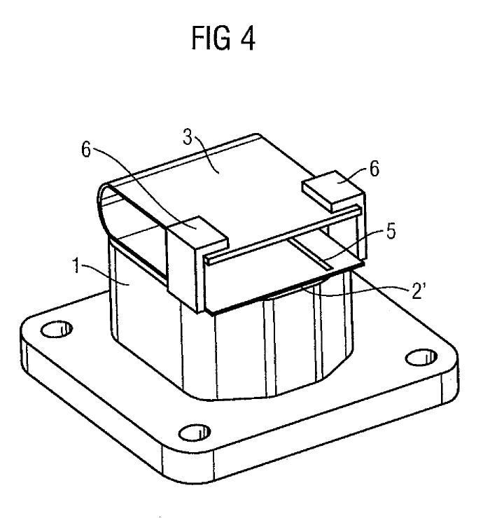

In FIG. 4 another embodiment of the valve depicted perspectively in the closed state. In contrast to the embodiments shown in FIG. 1 to FIG. 3, the elastic film element 3 is an elastic sheet-metal strip. The elastic film element 3 is here guided in two guides 6. These guides prevent the elastic film element 3 escaping laterally during operation and consequently improve the compact construction of the valve.

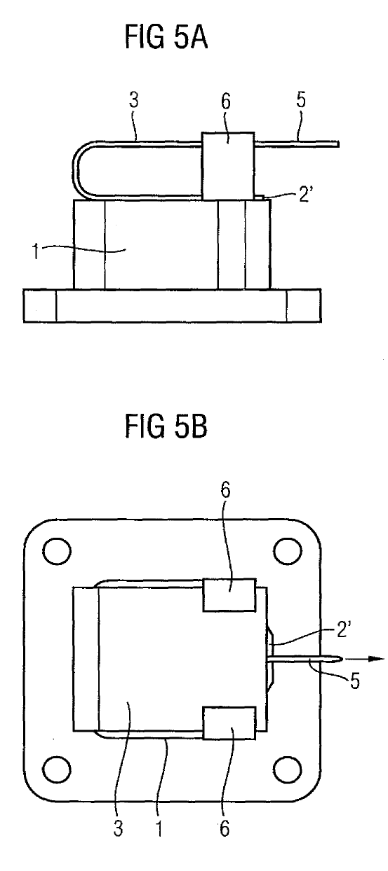

In FIG. 5a the alternative embodiment of the valve is represented in the closed state in the side view according to FIG. 4. In FIG. 5b the alternative development of the valve is represented in the closed state in top view. If the valve is to be brought from the closed state into the opened state, tensile forces are introduced into the elastic film element 3 via the transmission part 5 in the direction of the arrow.

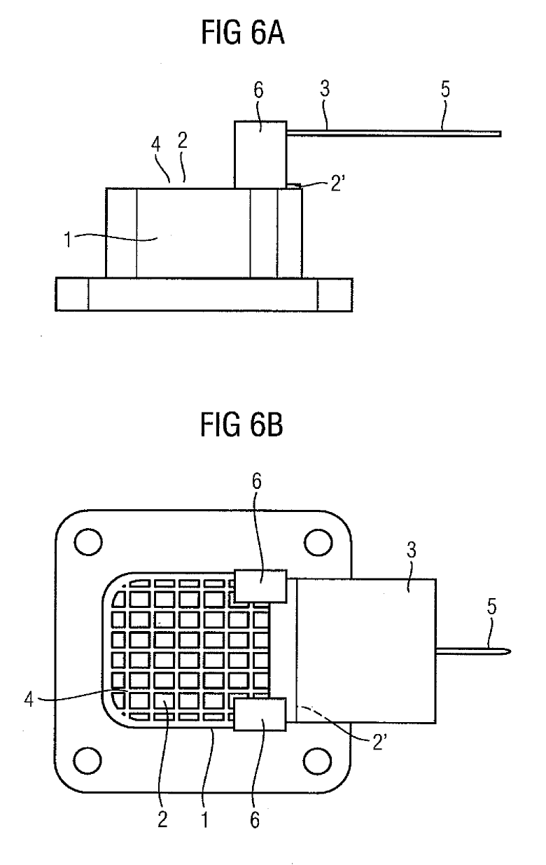

In FIG. 6a, the alternative development of the valve is represented in the opened state in side view. In FIG. 6b, the alternative development of the valve is represented in the opened state in top view. If the now opened valve is to be brought into the closed state again, it is necessary to introduce compressive forces into the elastic film element 3 via the transmission part 5 (not shown), so that this can then be displaced back onto the flat boundary of the flow opening 2 and onto the grille 4 until the closed state is attained.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-8. (canceled)

9. A device for generating a negative pressure in an inlet manifold of a diesel engine comprising:
a valve, wherein the valve comprises
a housing having a flow opening with a flat boundary; and
an elastic film element coupled to the housing, the elastic film element configured to close the flow opening when the elastic film element is in a flat state.

10. The device as claimed in claim 9, wherein one side of the flat boundary is connected to one end of the elastic film element.

11. The device as claimed in claim 9, wherein the elastic film element is connected to a transmission part for transmitting at least one of tensile and compressive force.

12. The device as claimed in claim 10, wherein the housing further comprises at least one guide configured to guide the elastic film element.

13. The device as claimed in claim 9, wherein the elastic film element is a scroll spring element.

14. The device as claimed in claim 9, wherein the elastic film element is an elastic sheet-metal strip.

15. The device as claimed in claim 9, wherein the flow opening is configured to enclose a grille at the flat boundary.

16. The device as claimed in claim 9, wherein, the device is a throttle element for a motor vehicle fitted with a diesel engine.

17. The device as claimed in claim 10, wherein the elastic film element is connected to a transmission part for transmitting at least one of tensile and compressive force.

18. The device as claimed in one of claims 13, wherein the elastic film element is an elastic sheet-metal strip.

19. The device as claimed in claim 12, wherein the elastic film element is an elastic sheet-metal strip.

20. The device as claimed in claim 12, wherein the guide is coupled to the housing at the one side of the flat boundary

21. A device for generating a negative pressure in an inlet manifold of a diesel engine including a valve, the valve comprising:
a housing having a flow opening with a flat boundary;
an elastic film element coupled to the housing, the elastic film element configured as a coil such that as the elastic film element is uncoiled it closes the flow opening.
